(19) United States
(12) Patent Application Publication
(10) Pub. No.: US 2024/0396261 A1
(43) Pub. Date: Nov. 28, 2024

(54) FAN GROUP WITH A MAGNETIC-TYPE CLAMPING CONNECTION MODULE

(71) Applicant: Anding FANG, Guangdong (CN)

(72) Inventor: Anding FANG, Guangdong (CN)

(21) Appl. No.: 18/206,616

(22) Filed: Jun. 7, 2023

(30) Foreign Application Priority Data
May 24, 2023 (CN) 2023212878168

(51) Int. Cl. H01R 13/62

(52) U.S. Cl. CPC H01R 13/6205; H01R 2201/00

(57) ABSTRACT

The present utility model discloses a fan group with a magnetic-type clamping connection module; the fan group comprises a housing and a connection module, wherein the outer wall of the said housing is arranged with four splicing sides, and the connecting end between two splicing sides is arranged with a concave locating groove, the upper and lower ends of the inner side of a locating groove are symmetrically arranged with stepped grooves, the connection module is arranged with a second magnetic member that matches the first magnetic member, the said connection module is arranged with stepped parts that fit the stepped grooves, and the walls of the base are arranged with second electrical connecting parts that fit the first electrical connecting parts. The combination of the first magnetic member and the second magnetic member makes it more convenient to combine or disassemble two fans.

### BACKGROUND OF THE INVENTION

The present utility model relates to the field of computer fans, in particular relating to a fan group with a magnetic-type clamping connection module.

Computer fans, also known as cooling fans, are generally used for heat dissipation. The cooling fans are provided for radiators and computer cases. The general cooling fans on the market range from 2.5 cm to 30 cm in diameter, and from 6 mm to 76 mm in thickness.

With the upgrading of computer hardware (graphics card, CPU), their working frequency also becomes higher; therefore, a single cooling fan cannot realize the expected heat dissipation effect, resulting in hardware damages.

As a result, generally, a plurality of single fans are connected in series through wires or the interfaces of the single fans are connected with the power supply respectively in order to realize the multi-fan operation and thus achieve the expected heat dissipation effect (for example, the single fans are installed as a cooling fan group or installed in a water-cooled radiator).

However, such structure results in more and messy electrical connection in a computer and thus easily results in unstable operation of fans. In other words, it is impossible to configure the cooling fans as per users' needs, meaning a significant limitation. Certainly, the cooling fans may be arranged with power interface modules; however, if the cooling fans are arranged with power interface modules, the assembly steps of the cooling fans will increase and the cost of a single fan will increase accordingly; take the Chinese patent numbered 202220594054.5 as an example, it is necessary to arrange the first electrical connecting parts and the second electrical connecting parts at different positions of the housing, meaning relatively cumbersome installation steps.

### BRIEF SUMMARY OF THE INVENTION

The main purpose of the present utility model is to propose a fan group with a magnetic-type clamping connection module, aiming to improve the existing fan combination structure, lower the cost of a single fan and thus reduce the assembly processes through the connection module.

To achieve the purpose described above, the present utility model provides a fan group with a magnetic-type clamping connection module, comprising:
a housing, wherein the outer wall of the said housing is arranged with four splicing sides, and the connecting end between two splicing sides is arranged with a concave locating groove, the upper and lower ends of the inner side of a locating groove are symmetrically arranged with stepped grooves, and a locating groove is arranged with a first electrical connecting part and a plurality of first electrical connecting parts in the same housing are mutually connected in series;
a locating groove is arranged with a first magnetic member;
a connection module, wherein the said connection module is a base arranged vertically and symmetrically, and its shape fits the combined shape of two locating grooves or fits the shape of a single locating groove,
the said connection module is arranged with a second magnetic member that matches the first magnetic member, the said connection module is arranged with stepped parts that fit the stepped grooves, and the walls of the base are arranged with second electrical connecting parts that fit the first electrical connecting parts.

In practical use of the technical solutions of the present utility model, the connecting module is arranged with stepped parts to make the base take on a symmetrical clamping structure;

When the housing is a whole, the size of the base fits the locating grooves and the base is arranged with one first electrical connecting part and one first magnetic member to realize electrical connection of independent fans, and four connecting ends of the housing can be placed at any positions as per the user's actual installation.

When the housing is divided into two halves, the size of the base fits the locating grooves and the base is arranged with two first electrical connecting parts and two first magnetic members to realize the splicing of two housing halves, mutual adsorption of the first magnetic members and the second magnetic members can realize the fixation between two fans; the structure is simple and the base of the connection module is more inexpensive when being made.

### BRIEF DESCRIPTION OF THE DRAWINGS

FIG. 1 is a stereoscopic schematic diagram of the present utility model;

FIG. 2 is a plane schematic diagram of the present utility model;

FIG. 3 is a schematic diagram when the connection module is arranged with two stepped parts;

FIG. 4 is a schematic diagram when the connection module is arranged with one stepped part;

FIG. 5 is a schematic diagram after the connection module partially conceals the base.

In the figures, 1—housing; 10—splicing side; 11—locating groove; 2—connection module; 20—PCB; 21—base; 31—stepped groove; 32—stepped part; 41—first magnetic member; 42—second magnetic member; 51—first electrical connecting part; 52—second electrical connecting part; 61—guide groove; 62—guide part; 7—connecting groove; 71—arc-shaped groove; 8—avoiding groove; 91—screw opening; 92—screw through opening.

### DETAILED DESCRIPTION OF THE INVENTION

The technical solutions of the present utility model will be described more clearly and fully in conjunction with the accompanying drawings of the present utility model, and obviously, the described embodiments are merely a part of the embodiments of the present utility model, not all the embodiments. Based on the embodiments of the present utility model, all the other embodiments obtained by the ordinary skilled in the art without creative labors belong to the scope claimed by the present utility model.

It should be noted that if an embodiment of the present utility model relates to directive instructions (such as upper, lower, left, right, front, rear, top, bottom, inside, outside, vertical, transverse, longitudinal, counter-clockwise, clockwise, circumferential, radial and axial), these directive instructions are merely used to explain the relative position relationship, the movement and so on among the components at certain specific posture (as shown in the accompanying drawings); if the specific posture changes, the directive instructions should be changed accordingly.

In addition, if an embodiment of the present utility model relates to the descriptions such as “first” and “second”, these descriptions are merely used for description and should not be understood to indicate or imply their relative importance or implicitly indicate the number of the corresponding technical features. This shows that the features limited with “first” and “second” can explicitly or implicitly include one such feature at least. Moreover, the technical solutions among the embodiments can be in combination with each other; however, such combination must be on the premise that those skilled in the art can realize the related technical solutions; when the technical solutions are inconsistent or cannot be realized, such combination of technical solutions should be deemed to be inexistent and not in the scope claimed by the present utility model.

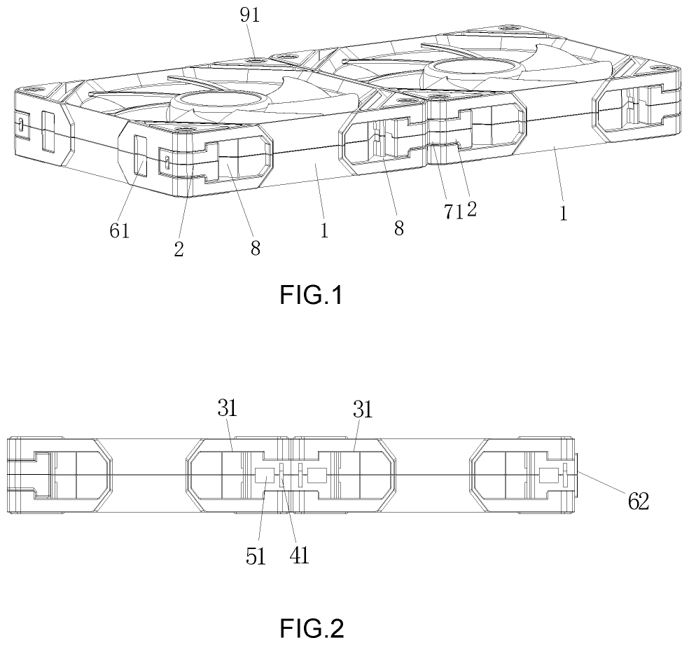

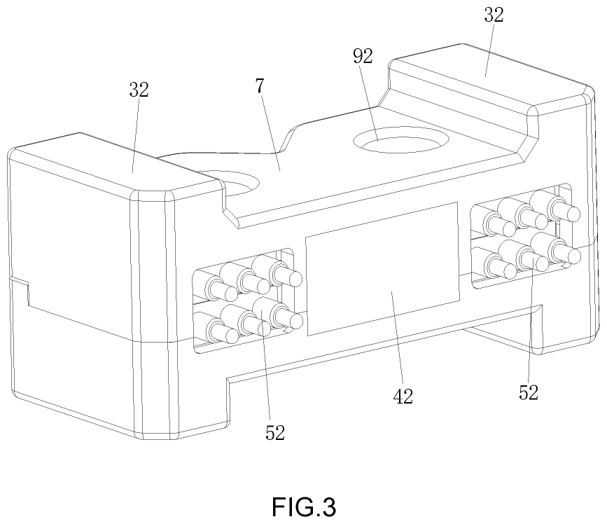

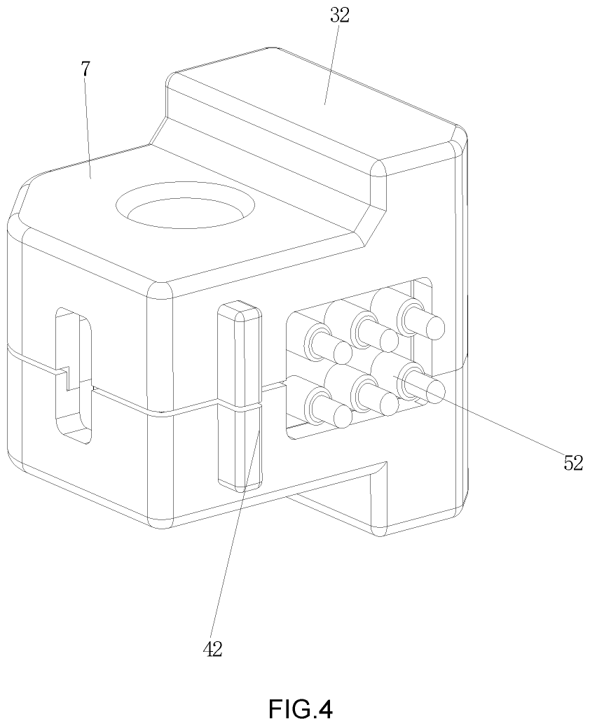

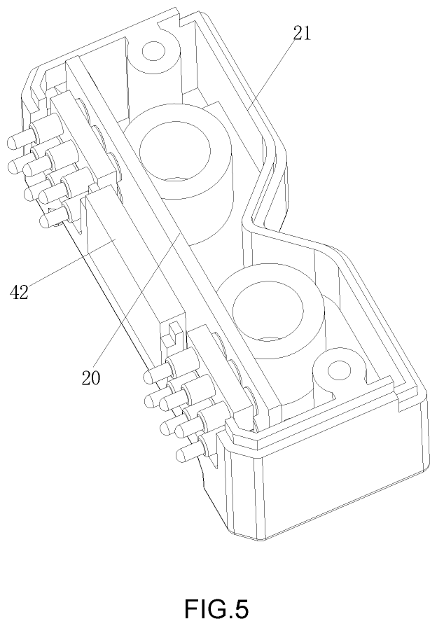

As shown from FIG. 1 to FIG. 5, a fan group with a magnetic-type clamping connection module comprises:
a housing (1), wherein the outer wall of the said housing (1) is arranged with four splicing sides (10), and the connecting end between two splicing sides (10) is arranged with a concave locating groove (11), the upper and lower ends of the inner side of a locating groove (11) are symmetrically arranged with stepped grooves (31), and a locating groove (11) is arranged with a first electrical connecting part (51) and a plurality of first electrical connecting parts (51) in the same housing (1) are mutually connected in series;
a locating groove (11) is arranged with a first magnetic member (41);
a connection module (2), wherein the said connection module (2) is a base (21) arranged vertically and symmetrically, and its shape fits the combined shape of two locating grooves (11) or fits the shape of a single locating groove (11),
the said connection module (2) is arranged with a second magnetic member (42) that matches the first magnetic member (41), the said connection module (2) is arranged with stepped parts (32) that fit the stepped grooves (31), and the walls of the base (21) are arranged with second electrical connecting parts (52) that fit the first electrical connecting parts (51).

In practical use, the connecting module (2) is arranged with stepped parts (32) to make the base (21) take on a symmetrical clamping structure;

When the housing (1) is a whole, the size of the base (21) fits the locating grooves (11) and the base (21) is arranged with one first electrical connecting part (51) and one first magnetic member (41) to realize electrical connection of independent fans, and four connecting ends of the housing (1) can be placed at any positions as per the user's actual installation.

When the housing (1) is divided into two halves, the size of the base (21) fits the locating grooves (11) and the base (21) is arranged with two first electrical connecting parts (51) and two first magnetic members (41) to realize the splicing of two housing halves, and mutual adsorption of the first magnetic members (41) and the second magnetic members (42) can realize the fixation between two fans; the structure is simple and the base (21) of the connection module (2) is more inexpensive when being made.

Concretely, two opposite splicing sides (10) are respectively arranged with a concave guide groove (61) and a convex guide part (62), and the said guide part (62) can extend into the said guide groove (61) to preliminarily locate and fix the housing (1).

More concretely, the said base (21) is arranged inside with a PCB (20), and when there are two second electrical connecting parts (52), the said second electrical connecting parts (52) will be spaced on the PCB (20) to simplify the structure of the connection module (2).

In an embodiment of the present utility model, when there are two stepped parts (32), the said two stepped parts (32) will form a staggered connecting part (70), and the outer wall of the said connecting part (7) is arranged with an inner concave arc-shaped groove (71). The design makes the transition more natural after the connection module (2) is installed behind two fans.

Further, the said connection module (2) is installed behind the locating grooves (11), and at the positions of the said locating grooves (11) away from the said first magnetic members (41) are arranged with avoiding grooves (8) at a distance from the walls of the base (21), and the avoiding grooves (8) facilitate the disassembly of the said connection module (2).

Further, each of the said connecting ends is arranged with a screw opening (91), and the said base (21) is arranged with screw through openings (92) that match the screw openings (91) to make the fans become more stable after be fixed.

In an embodiment of the present utility model, the said first electrical connecting parts (51) are electrode plates, and the second electrical connecting parts (52) are PIN needles.

Concretely, the said second magnetic members are arranged at the positions of the connecting parts.

In an embodiment of the present utility model, the said second electrical connecting parts (52) are arranged at the positions of the stepped parts (32).

The embodiments described above are merely the preferred embodiments of the present utility model, not to limit the patent scope of the present utility model, with the conception of the present utility model, any equivalent structure transformation using the Specifications and the accompanying drawings of the present utility model or direct/indirect applications to other related technical fields should be included in the scope claimed by the present utility model.

What is claimed is:

1. A fan group with a magnetic-type clamping connection module, characterized in that it comprises:
a housing, wherein the outer wall of the said housing is arranged with four splicing sides, and the connecting end between two splicing sides is arranged with a concave locating groove, the upper and lower ends of the inner side of a locating groove are symmetrically arranged with stepped grooves, and the height of stepped grooves is greater than the height of the locating grooves, and a locating groove is arranged with a first electrical connecting part and a plurality of first electrical connecting parts in the same housing are mutually connected in series;
a locating groove is arranged with a first magnetic member;
a connection module, wherein the said connection module is a base arranged vertically and symmetrically, and its shape fits the combined shape of two locating grooves or fits the shape of a single locating groove,
the said connection module is arranged with a second magnetic member that matches the first magnetic member, the said connection module is arranged with stepped parts that fit the stepped grooves, and the walls of the base are arranged with second electrical connecting parts that fit the first electrical connecting parts.

2. The fan group with a magnetic-type clamping connection module in accordance with claim 1, characterized in that two opposite splicing sides are respectively arranged with a concave guide groove and a convex guide part, and the said guide part can extend into the said guide groove.

3. The fan group with a magnetic-type clamping connection module in accordance with claim 1, characterized in that the said base is arranged inside with a PCB, and when there are two second electrical connecting parts, the said second electrical connecting parts will be spaced on the PCB.

4. The fan group with a magnetic-type clamping connection module in accordance with claim 1, characterized in that when there are two stepped parts, the said two stepped parts will form a staggered connecting part, and the outer wall of the said connecting part is arranged with an inner concave arc-shaped groove.

5. The fan group with a magnetic-type clamping connection module in accordance with claim 1, characterized in that the said connection module is installed behind the locating grooves, and at the positions of the said locating grooves away from the said first magnetic members are arranged with avoiding grooves at a distance from the walls of the base.

6. The fan group with a magnetic-type clamping connection module in accordance with claim 1, characterized in that each of the said connecting ends is arranged with a screw opening, and the said base is arranged with screw through openings that match the screw openings.

7. The fan group with a magnetic-type clamping connection module in accordance with claim 1, characterized in that the said first electrical connecting parts are electrode plates, and the second electrical connecting parts are PIN needles.

8. The fan group with a magnetic-type clamping connection module in accordance with claim 4, characterized in that the said second magnetic members are arranged at the positions of the connecting parts.

9. The fan group with a magnetic-type clamping connection module in accordance with claim 1, characterized in that the said second electrical connecting parts are arranged at the positions of the stepped parts.
